(19) United States
(12) Patent Application Publication
(10) Pub. No.: US 2009/0151005 A1
(43) Pub. Date: Jun. 11, 2009

(54) METHOD FOR IDENTITY THEFT PROTECTION WITH SELF-DESTRUCTING INFORMATION

(75) Inventors: Kevin H. Bell, Wake Forest, NC (US); Phuc K. Do, Morrisville, NC (US); Javier H. Santiago, Youngville, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/950,745

(22) Filed: Dec. 5, 2007

(51) Int. Cl. H04L 9/32

(52) U.S. Cl. 726/28; 726/26

(57) ABSTRACT

A method for identity theft protection includes receiving an identity theft indicator indicating a possible loss or theft of a personal device, wherein the identity theft indicator includes at least one of a user-initiated signal, a geographic range indicator, an expired timer, a failure of a heart-beat verification, and a battery level indicator. The method further includes attempting contact of an owner of the personal device, wherein attempting contact includes at least one of transmitting a message to the owner over a telephone connection, transmitting an email to a registered email address of the owner, and transmitting a text-based message to a registered telephone number on the personal device. The method further includes protecting information stored on the personal device if attempting contact of the owner is not successful.

### TRADEMARKS

IBM ® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to identity theft prevention. More particularly, this invention relates to identity theft protection with self-destructing information.

2. Description of Background

Generally, personal devices such as personal digital assistants (PDA), cellular telephones, portable music devices, and other personal devices are used to store personal and/or sensitive information. In the wrong hands, a misplaced or stolen personal device containing personal information may cause a significant amount of damage given recent trends in identity theft. Further, more and more personal information is being carried on persons on a plurality of different devices, making it increasingly difficult to manage and/or locate every device at all times. Therefore, losing these devices may provide the finder (or thief) easy access to personal information with a large time-window before an owner realizes a device is missing. Conventional methods of information protection available to personal devices provides some protection, however, all information typically remains on the devices. As such, the information is still available to a person, or persons, who find the lost or stolen devices.

### SUMMARY

A method of identity theft protection includes receiving an identity theft indicator indicating a possible loss or theft of a personal device, wherein the identity theft indicator includes at least one of a user-initiated signal, a geographic range indicator, an expired timer, a failure of a heart-beat verification, and a battery level indicator. The method further includes attempting contact of an owner of the personal device, wherein attempting contact includes at least one of transmitting a message to the owner over a telephone connection, transmitting an email to a registered email address of the owner, and transmitting a text-based message to a registered telephone number on the personal device. The method further includes protecting information stored on the personal device if attempting contact of the owner is not successful, wherein protecting information includes encoding the information, transmitting the encoded information to one of a secure server or the registered email address of the owner, and destroying the information on the personal device.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a method of identity theft protection, according to an exemplary embodiment:

FIG. 2 illustrates a method of identity then protection, according to an exemplary embodiment;

FIG. 3 illustrates a method of information recovery, according to an exemplary embodiment; and

FIG. 4 illustrates a system with identity theft protection, according to an exemplary embodiment.

The detailed description explains an exemplary embodiment, together with advantages and features, by way of example with reference to the drawings.

### DETAILED DESCRIPTION

According to an exemplary embodiment, identity theft protection may be provided with self-destructing information. The self-destructing information may automatically detect if a personal device has been stolen, and erase any sensitive information on the personal device, thereby significantly increasing the protection of personal information stored on personal devices.

According to an example embodiment, if a personal device receives an indicator identifying that the personal device may not be in the control of the owner, it begins an information protection scheme. The indicators may include, but should not be limited to, a user-initiated signal (e.g., after theft of a device), out of a particular geographic range (e.g., using a GPS component on the device), identification of a transaction occurring at one geographic location while the owner is at a second geographic location (i.e., using a credit card company's aid and a GPS component), an expired timer, failure of a heart-beat check, and/or battery level or failure indicator.

The user-initiated signal may be issued by an owner of the device over a web-interface or other similar connection. The connection may be a secure connection over which the user or owner may issue a password or other personal identification means. If the device detects it is out of a particular geographic range using an on-board GPS component, it may also initiate the protection scheme. For example, the device may verify a particular range based on a personal calendar stored on the device, or other location specific information for the user, not limited to account services location, home location, business location, or other similar information.

With regards to a transaction indicator, the device may be notified by a credit card or web-payment service that a transaction is occurring at one geographic location (i.e., the actual owner is using a credit card) while the device is registering at a different geographic location based on an on-board GPS component. Therefore, as the owner may not be located at two distinct geographic locations at once, it would follow that theft or loss of the device has occurred. Furthermore, timers may be used to establish ownership. For example, a timer may be set based on typical device usage. If a timer expires indicating the owner has not used the device over a specified or desired time-range, the device may have been lost. Similarly, if the battery on-board the device is at a low-level without being charged, it may indicate that the device has been lost or stolen.

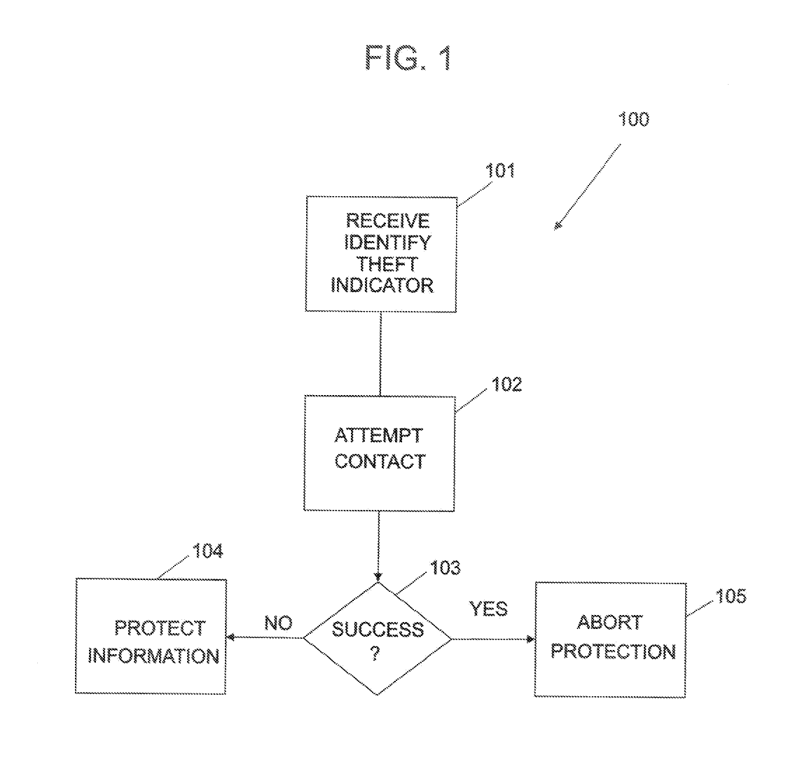

If any of the above or other triggers/indicators occur, the device may initiate a protection scheme to protect the owner from identity theft. Hereinafter, a method of identity theft protection is described with reference to FIG. 1.

As illustrated, the method 100 includes receiving an identity theft indicator at block 101. The indicator may be one or more of the indicators mentioned above, or any other suitable indicator. Upon receipt, or at substantially the same time as receipt, the device may attempt to contact the owner at block 102. For example, the device may send a secure email to the owner's registered account, or initiate a voice-call to a home or other telephone number registered by the owner. Alternatively, the device may simply initiate a lock sequence for a desired or specified amount of time. The lock sequence may be disabled through a biometric sensor or password verification.

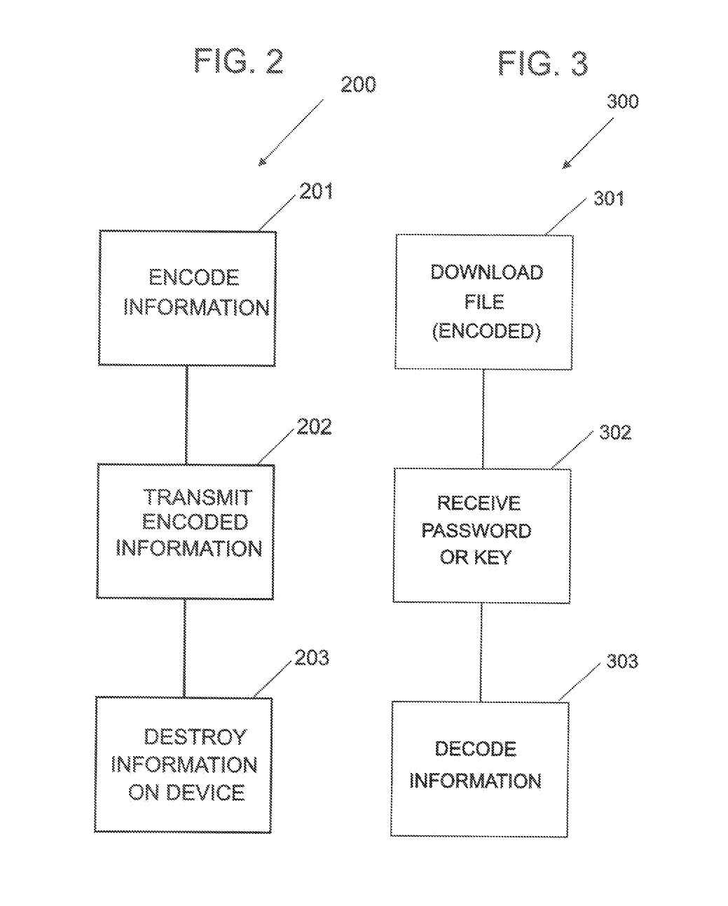

If contact with the owner is unsuccessful, the method 100 includes protecting information stored on the device at block 104. If contact with the user is successful, the device may abort the protection sequence at block 105. Additionally, a timer may be set until the protection sequence is initiated again to ensure the owner locates the device before identity theft occurs. Such maybe similar to the temporary lock described hereinbefore. Turning to FIG. 2, the protection sequence is described in more detail.

FIG. 2 illustrates a method of identity theft protection, according to an example embodiment. As illustrated, the method 200 includes encoding information at block 201. The device may encode personal information, flagged information, or all information depending upon particular setting desired by an owner of the device. Upon encoding, the method 200 includes transmitting the encoded information at block 202. For example, the encoded information may be transmitted to a registered email address, or uploaded to a secure file server for future use by the owner. After successful transmission, the pertinent information, or desired information is completely erased from the device at block 203. Erasure may be performed by a variety of methods known in the art. For example, all logical zeros or ones may be written over the information on a storage device of the personal device. Although the information is now secure and protected, an owner may wish to restore the information on a new or recovered device. As such, FIG. 3 illustrates a method of restoring information, according to an example embodiment.

As illustrated, the method 300 includes downloading a file at block 301. For example, the file may be a file previously uploaded by the device, containing the encoded information that was previously erased. Alternatively, the file may be a file that was uploaded at a desired or specified back-up interval to ensure protection from device failure. Upon download of the file, the method includes receiving a password or key at block 302. The password may be issued by the owner when accessing the download at block 301. Alternatively, a shared key may be stored on the file such that block 302 is automatic. Thereafter, the method 300 includes decoding the information at block 303.

It is noted that example embodiments do not preclude the possibility of disablement of the self-destruct mechanism. For example, the owner of the device may disable the self-destruct mechanism with a signal transmitted through a web-service or secure connection, through public/private keys and handshake recognition, biometric sensors on the device, transmission of a text message or message when telephoning the device, or other similar methods. Further, it is noted that according to example embodiments, the self-destructing data may be erased completely if the device is tampered with by a thief. For example, the device may be equipped with a sensor to detect if the device's case is opened or memory is being accessed externally.

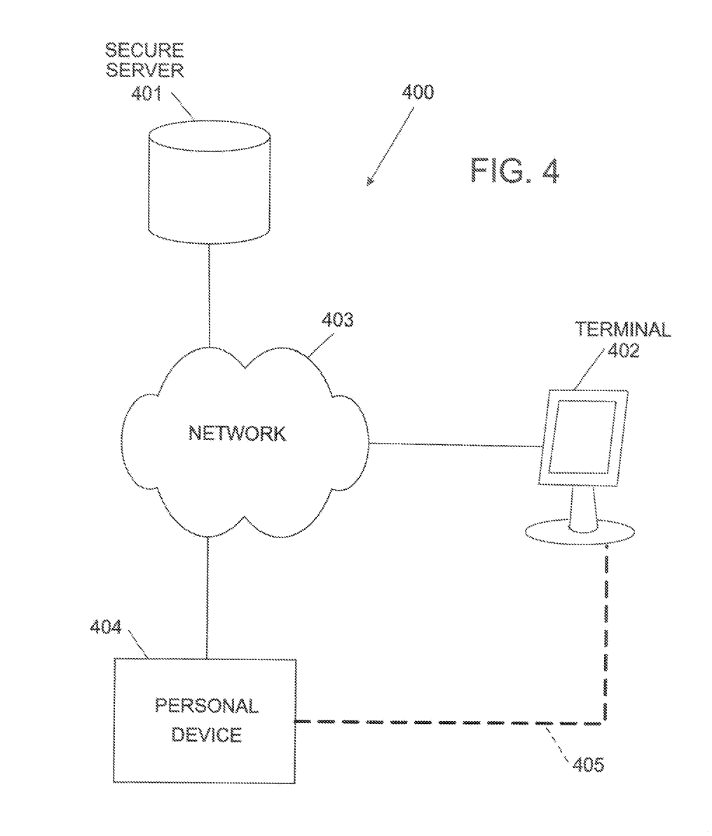

Turning now to FIG. 4, a system with identity theft protection is illustrated according to an example embodiment. The system may include a secure server 401 in operative communication with a network 403. The secure server 401 may store files unloaded by personal devices and store said files until access by an authorized user. The system 400 further includes a personal device 404 in operative communication with the network 403. The personal device may communicate with the secure server 401 over the network 403. The system 400 further includes a terminal 402. For example, the terminal 402 may be used to access an owner's email account to retrieve an encoded file transmitted by the personal device 404. In at least one example embodiment, the personal device 404 may be operatively connected to the terminal 402 over connection 405. Therefore, an owner may directly download the encoded file for data recovery if the personal device 404 is recovered.

According to an exemplary embodiment, the method described hereinbefore may be implemented by a computer system or apparatus. Therefore, portions or the entirety of the method may be executed as instructions in a processor of the computer system. The computer system may be a cellular telephone, PDA, portable music player, portable laptop computer, or other suitable device. Thus, the present invention may be implemented, in software, for example, as any suitable computer program. For example, a program in accordance with the present invention may be a computer program product causing a computer to execute the example method described herein.

The computer program product may include a computer-readable medium having computer program logic or code portions embodied thereon for enabling a processor of a computer apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer apparatus, may enable the method described herein.

While an exemplary embodiment has been described, it will be understood that those skilled in the art, both now and in the future, may make various improvements and enhancements which fall within the scope of the claims which follow. These claims should be construed to maintain the proper protection for the invention first described.

What is claimed is:

1. A method of identity theft protection, comprising:
receiving an identity theft indicator indicating a possible loss or theft of a personal device, wherein the identity theft indicator includes at least one of,
a user-initiated signal a geographic range indicator, an expired timer, a failure of a heart-beat verification, and a battery level indicator;
attempting contact of an owner of the personal device, wherein attempting contact includes at least one of,
transmitting a message to the owner over a telephone connection, transmitting an email to a registered email address of the owner, and transmitting a text-based message to a registered telephone number on the personal device; and
protecting information stored on the personal device if attempting contact of the owner is not successful, wherein protecting information includes,
encoding the information,
transmitting the encoded information to one of a secure server or the registered email address of the owner, and
destroying the information on the personal device.

2. The method of claim 1, further comprising recovering the destroyed information, wherein recovering the destroyed information includes:
downloading the encoded information from one of the secure server or the registered email address of the owner;
verifying ownership through receipt of a password, shared key, or biometric identification; and
decoding the encoded information on the personal device.

3. The method of claim 1, wherein destroying the information includes one of writing logical zeros over the information on the personal device and writing logical ones over the information on the personal device.

4. The method of claim 1, further comprising enabling an automatic locking system on the personal device if contacting the owner is successful.

5. The method of claim 4, further comprising disabling the automatic locking mechanism on the personal device if the owner successfully verifies identification on the device, wherein the identification includes one of:
a biometric reading on the personal device;
a password; and
a shared key.
